(19) United States
(12) Patent Application Publication
(10) Pub. No.: US 2011/0228873 A1
(43) Pub. Date: Sep. 22, 2011

(54) APPARATUS FOR TRANSMITTING DIGITAL BROADCAST AND METHOD FOR TRANSMITTING DATA USING THE SAME IN DIGITAL BROADCASTING SYSTEM

(75) Inventors: Jeongchang KIM, Daejeon (KR); Sung-Ik PARK, Daejeon (KR); Heung-Mook KIM, Daejeon (KR); Wangrok OH, Daejeon (KR); Donghoon KANG, Daejeon (KR)

(73) Assignees: Electronics and Telecommunications Research Institute, Daejeon (KR); The Industry & Academic Cooperation in Chungnam National University (IAC), Daejeon (KR)

(21) Appl. No.: 13/051,673

(22) Filed: Mar. 18, 2011

(30) Foreign Application Priority Data
Mar. 19, 2010 (KR) 10-2010-0024950
Oct. 19, 2010 (KR) 10-2010-0101856

(51) Int. Cl. H04L 27/00

(52) U.S. Cl. 375/295

(57) ABSTRACT

An apparatus for transmitting digital broadcasts includes: a main service data generation unit configured to generate main service data; an additional data generation unit configured to generate plural pieces of additional data; a spreading unit configured to spread the plural pieces of additional data using different spreading sequences, respectively; and a transmission unit configured to couple each of the plural pieces of spread additional data with the main service data and transmit the coupled data.

### CROSS-REFERENCES TO RELATED APPLICATIONS

The present application claims priority of Korean Patent Application Nos. 10-2010-0024950 and 10-2010-0101856, filed on Mar. 19, 2010, and Oct. 19, 2010, respectively, which are incorporated herein by reference in their entirety.

### BACKGROUND OF THE INVENTION

1. Field of the Invention

Exemplary embodiments of the present invention relate to a digital broadcasting system; and, more particularly, to an apparatus for transmitting digital broadcasts in a digital broadcasting system with improved broadcasting data transmission performance and a method for transmitting data using the same.

2. Description of Related Art

In general, a digital broadcasting system refers to a system configured to provide digital broadcasts, which replace existing analog broadcasts and provide services of improved video and audio quality.

A digital broadcast transmission apparatus adds main service data for terrestrial digital TV broadcasting to broadcasting data and provides a digital broadcast reception apparatus with the data. Users increasingly demand that, besides broadcasting data, various types of additional data be provided through current broadcasting systems. Therefore, broadcasting data includes main service data for terrestrial broadcasting, as well as additional data. Each of main service data and additional data, which are included in broadcasting data, is transmitted as a single data stream.

In order to provide various types of information in digital broadcasting systems, broadcasting data (e.g. additional data) is on the gradual increase. However, there are limitations in improving broadcasting data transmission performance solely by a single data stream.

### SUMMARY OF THE INVENTION

An embodiment of the present invention is directed to an apparatus for broadcasting digital broadcasts with improved data transmission performance and a method for transmitting data using the same in a digital broadcasting system.

Another embodiment of the present invention is directed to an apparatus for transmitting digital broadcasts with improved additional data transmission performance and a method for transmitting data using the same in a digital broadcasting system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for transmitting digital broadcasts in a digital broadcasting system includes: a main service data generation unit configured to generate main service data; an additional data generation unit configured to generate plural pieces of additional data; a spreading unit configured to spread the plural pieces of additional data using different plural pieces of spreading sequences, respectively; and a transmission unit configured to couple each of the plural pieces of spread additional data with the main service data and transmit the coupled data into a single piece of broadcasting data.

The main service data generation unit may include a main service data generator configured to generate the main service data.

The additional data generation unit may include: an additional data generator configured to generate the plural pieces of additional data; and an additional data distribution unit configured to distribute the plural pieces of additional data, respectively.

The spreading unit may include: channel encoders configured to channel-encode the plural pieces of additional data, respectively; and spreaders configured to spread the plural pieces of channel-encoded additional data using the different plural pieces of spreading sequences, respectively.

The spreading unit may further include average power regulators configured to regulate average power of the plural pieces of additional data spread by the spreaders, respectively.

The transmission unit may include: a coupler configured to couple the main service data and the plural pieces of average power-regulated additional data and generate the single piece of broadcasting data; a modulator configured to modulate the generated single piece of broadcasting data according to a predetermined modulation scheme; and a transmitter configured to transmit the modulated single piece of broadcasting data.

The main service data generator may further include a first modulator configured to modulate the main service data.

The spreading unit may further include: second modulators configured to modulate the plural pieces of spread additional data, respectively; and first average power regulators configured to regulate average power of the plural pieces of modulated additional data, respectively.

The transmission unit may include: a coupler configured to couple the modulated main service data and the plural pieces of average power-regulated additional data and generate the single piece of broadcasting data; and a transmitter configured to transmit the single piece of broadcasting data.

The spreading unit may further include: second average power regulators configured to regulate average power of part of the plural pieces of spread additional data, respectively; a first coupler configured to couple the plural pieces of average power-regulated additional data by the second average power regulators; and a third modulator configured to modulate the plural pieces of coupled additional data by the first coupler.

The transmission unit may include: a coupler configured to couple the modulated main service data, the plural pieces of average power-regulated additional data by the first average power regulators, and the plural pieces of modulated additional data by the third modulator and generate the single piece of broadcasting data; and a transmitter configured to transmit the single piece of broadcasting data.

In accordance with another embodiment of the present invention, an apparatus for transmitting digital broadcasts in a digital broadcasting system includes: a main service data generator configured to generate main service data; a first modulator configured to modulate the main service data according to a predetermined first modulation scheme; an additional data generator configured to generate additional data; an additional data distributor configured to distribute the additional data into plural pieces of additional data; spreaders configured to spread the plural pieces of distributed additional data using different plural pieces of predetermined spreading sequences, respectively; second modulators configured to modulate the plural pieces of spread additional data according to a predetermined second modulation scheme, respectively; a first coupler configured to couple the modulated main service data and each of the plural pieces of modulated additional data and generate a single piece of broadcasting data; and a transmitter configured to signal-process the single piece of broadcasting data and transmit the signal-processed single piece of broadcasting data.

The apparatus may further include channel encoders configured to channel-encode the plural pieces of distributed additional data and output the spreaders with the plural pieces of channel-encoded additional data, respectively.

The apparatus may further include average power regulators configured to regulate average power of the plural pieces of modulated additional data and output the plural pieces of average power-regulated additional data to the first coupler, respectively.

The apparatus may further include: a second coupler configured to couple part of the plural pieces of spread additional data; and a third modulator configured to modulate the additional data coupled by the second coupler according to a predetermined third modulation scheme and output the modulated additional data to the first coupler.

In accordance with another embodiment of the present invention, an apparatus for transmitting digital broadcasts in a digital broadcasting system includes: a main service data generator configured to generate main service data; an additional data generator configured to generate additional data; an additional data distributor configured to distribute the additional data into plural pieces of additional data; spreaders configured to spread the plural pieces of distributed additional data using different plural pieces of predetermined spreading sequences, respectively; a coupler configured to couple the main service data and each of the plural pieces of spread additional data and generate a single piece of broadcasting data; a modulator configured to modulate the single piece of broadcasting data according to a predetermined modulation scheme; and a transmitter configured to signal-process the single piece of modulated broadcasting data and transmit the single piece of signal-processed broadcasting data.

The apparatus may further include channel encoders configured to channel-encode the plural pieces of distributed additional data and output the plural pieces of channel-encoded additional data to the spreaders, respectively.

The apparatus may further include average power regulators configured to regulate average power of each of the plural pieces of spread additional data and output the average power-regulated additional data to the coupler.

In accordance with another embodiment of the present invention, a method for transmitting data by a digital broadcast transmission apparatus in a digital broadcasting system includes: generating main service data and additional data; distributing the additional data into plural pieces of additional data; spreading the plural pieces of distributed additional data using different plural pieces of spreading sequences, respectively; and coupling the main service data and the plural pieces of spread additional data and transmitting the single piece of coupled data.

The plural pieces of spreading sequences have orthogonality with regard to one another, respectively.

### BRIEF DESCRIPTION OF THE DRAWINGS

FIG. 1 illustrates the structure of a digital broadcasting system in accordance with an embodiment of the present invention.

FIG. 2 illustrates the structure of a digital broadcast transmission apparatus in a digital broadcasting system in accordance with an embodiment of the present invention.

FIG. 3 illustrates the structure of a digital broadcast transmission apparatus in a digital broadcasting system in accordance with another embodiment of the present invention.

FIG. 4 illustrates the structure of a digital broadcast transmission apparatus in a digital broadcasting system in accordance with still another embodiment of the present invention.

FIG. 5 illustrates exemplary operation of a digital broadcast transmission apparatus in a digital broadcasting system in accordance with an embodiment of the present invention.

FIG. 6 illustrates exemplary operation of a digital broadcast reception apparatus in a digital broadcasting system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

According to an apparatus and a method for transmitting signals in a digital broadcasting system proposed by the present invention, additional data is added to a piece of broadcasting data using different a plurality of spreading sequences, respectively, and then simultaneously transmitted, thereby improving data transmission performance.

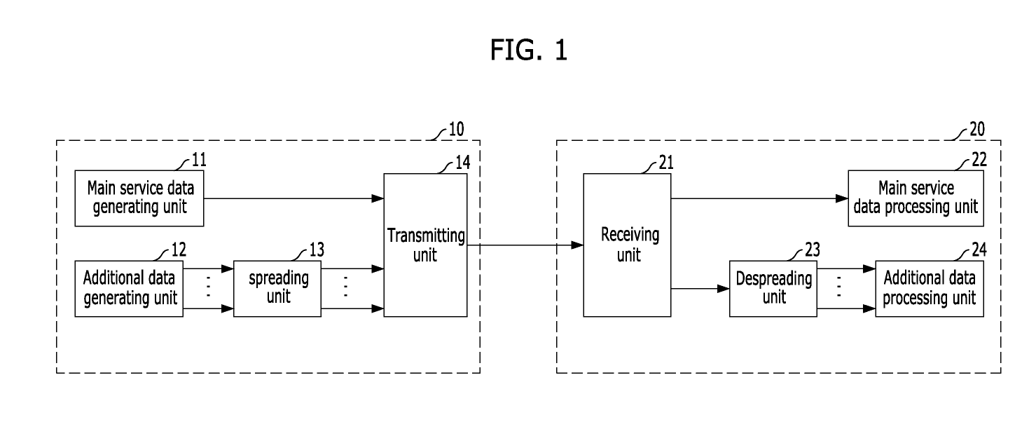

FIG. 1 illustrates the structure of a digital broadcasting system in accordance with an embodiment of the present invention.

Referring to FIG. 1, the digital broadcasting system includes a digital broadcast transmission apparatus 10 and a digital broadcast reception apparatus 20.

The digital broadcast transmission apparatus 10 includes a main service data generation unit 11, an additional data generation unit 12, a spreading unit 13, and a transmission unit 14.

The main service data generation unit 11 is configured to generate main service data. As used herein, main service data is, for example, a data stream for a terrestrial digital TV broadcasting service.

The additional data generation unit 12 is configured to generate additional data, which refers to a data stream that can be provided in addition to the main service data. The additional data, for example, includes broadcasting data for other broadcasting services than the terrestrial TV broadcasting service. The additional data may also include various types of data for additional information provision, e.g. education data, advertising data, stocks data, public service advertising data, metadata, weather data, news data, movie data, shopping data, sports data, etc.

The additional data generation unit 12 is configured to distribute additional data into plural pieces of additional data. The additional data generation unit 12 may consider the kind, type, or size of additional data when distributing it.

The spreading unit 13 is configured to spread the plural pieces of distributed additional data using different spreading sequences, respectively, so that the plural pieces of distributed additional data and the main service data are merged into a single piece of broadcasting data and then simultaneously transmitted, in particular the additional data are simultaneously transmitted.

The transmission unit 14 is configured to couple the plural pieces of spread additional data to the main service data to generate a single piece of broadcasting data and transmit the single piece of generated broadcasting data. Wherein the transmission unit 14 simultaneously transmits the plural pieces of additional data into the single piece of broadcasting data.

The digital broadcast reception apparatus 20 includes a reception unit 21, a main service data processing unit 22, a despreading unit 23, and an additional data processing unit 24.

The reception unit 21 is configured to receive broadcasting data and separate main service data and additional data, which has been spread by spreading sequences, from the received broadcasting data.

The main service data processing unit 22 is configured to process main service data for digital broadcasting service provision.

The despreading unit 23 is configured to extract plural pieces of additional data from the spread additional data by using despreading sequences corresponding to the spreading sequences of the spreading unit 13.

The additional data processing unit 24 is configured to process the plural pieces of extracted additional data.

The digital broadcast transmission apparatus 10 and the digital broadcast reception apparatus 20 can be connected to each other in a wired or wireless manner. In the case of wireless connection, the transmission unit 14 of the digital broadcast transmission apparatus 10 and the reception unit 21 of the digital broadcast reception apparatus 20 can process transmitted/received wireless signals. The digital broadcast transmission apparatus 10 can include broadcasting station equipment, for example, and the digital broadcast reception apparatus 20 can include, for example, a user terminal device such as a set-top box or a TV set.

When additional data is to be transmitted in accordance with the present invention, it is divided into plural pieces of additional data, which are spread using a plurality of spreading sequences, respectively, and then simultaneously transmitted between the digital broadcast transmission apparatus 10 and the digital broadcast reception apparatus 20. This improves broadcasting data transmission performance compared with transmission of a single piece of additional data among the plural pieces of additional data, respectively.

As a result, the broadcasting system in accordance with the present invention includes a larger size of data inside broadcasting data and then transmits, which is transmitted within the same time interval, compared with conventional digital broadcasting systems.

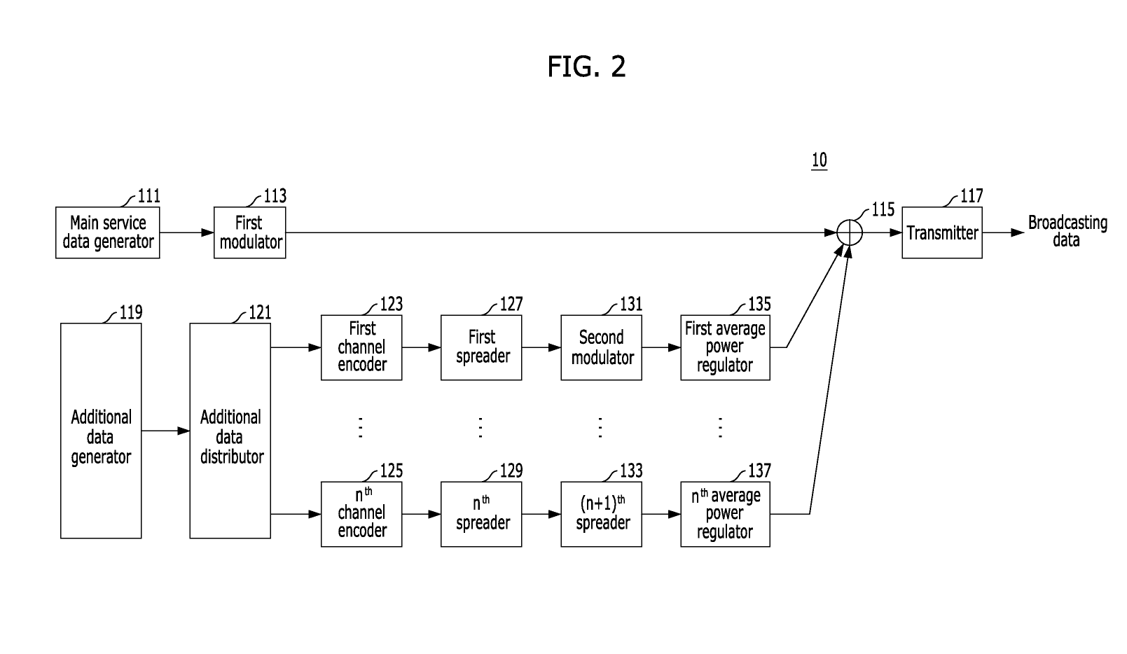

FIG. 2 illustrates the structure of a digital broadcast transmission apparatus in a digital broadcasting system in accordance with an embodiment of the present invention.

Referring to FIG. 2, the digital broadcast transmission apparatus 10 includes a main service data generation unit 11, an additional data generation unit 12, a spreading unit 13, and a transmission unit 14.

The main service data generation unit 11 includes a main service data generator 111 and a first modulator 113. The additional data generation unit 12 includes an additional data generator 119 and an additional data distributor 121. The spreading unit 13 includes channel encoders 123 and 125, spreaders 127 and 129, modulators 131 and 133, and average power regulators 135 and 137. The transmission unit 14 includes a coupler 115 and a transmitter 117.

The digital broadcast transmission apparatus 10 of FIG. 2 can be used when main service data and additional data are modulated by different modulators 113, 131, and 133.

The main service data generator 111 is configured to generate main service data and output the generated main service data to the first modulator 113.

The first modulator 113 is configured to modulate the main service data according to a predetermined first modulation scheme and output the modulated main service data to the coupler 115.

The additional data generator 119 is configured to generate additional data and output the generated additional data to the additional data distributor 121.

The additional data distributor 121 is configured to distribute the additional data into plural pieces of additional data. The additional data distributor 121 may consider the kind, type, or size of additional data when distributing it. The additional data distributor 121 is configured to output the pieces of distributed additional data to the first to n^{th} channel encoders 123 to 125, respectively.

Each of the first to n^{th} channel encoders 123 to 125 is configured to perform channel encoding with regard to one of the plural pieces of additional data, respectively. As used herein, channel encoding refers to an encoding technique for reducing errors on the transmission path. For example, the first channel encoder 123 can insert redundancy for error detection and correction by the digital broadcast reception apparatus 20.

For example, the first channel encoder 123 can encode one of the plural pieces of additional data in the type of a channel encoding symbol. The first channel encoder 123 is configured to output the channel-encoded additional data to the first spreader 127. Remaining channel encoders 125 are configured to perform similar operations as the first channel encoder 123. Each of the first to n^{th} channel encoders 123 to 125 may have the same channel encoding scheme, or a different one. Alternatively, only some of the channel encoders among the channel encoders 123, 125 may have the same channel encoding scheme.

Each of the first to n^{th} channel spreaders 127 to 129 is configured to spread each piece of the channel-encoded additional data using a different spreading sequence. The spreading sequences may have orthogonality with regard to each other.

For example, the first spreader 127 is configured to spread additional data, which has been channel-encoded by the first channel encoder 123, using a first spreading sequence. The first spreader 127 is configured to output the spread additional data to the second modulator 131. Remaining spreaders 129 are configured to perform similar operations as the first spreader 127. The n^{th} spreader 129 may use an n^{th} spreading sequence to spread additional data. Therefore, the first and n^{th} spreading sequences are different ones.

Each of the second to (n+1)^{th} modulators 131 to 133 is configured to modulate each piece of additional data, which has been spread using a different spreading sequence, according to a predetermined modulation scheme.

For example, the second modulator 131 is configured to modulate additional data, which has been spread by the first spreader 133, according to a predetermined second modulation scheme and output the modulated additional data to the first average power regulator 135. Remaining modulators 133 are configured to perform similar operations as the first modulator 131. The (n+1)^{th} modulator 133 may use a (n+1)^{th} modulation scheme to modulate additional data. The first modulation scheme of the first modulator 113, the second modulation scheme of the second modulator 131, and the (n+1)^{th} modulation scheme of the (n+1)^{th} modulator 133 may be all the same, or different from one another. Alternatively, only some of the modulators among the modulators 113, 131, 133 may have the same modulation scheme.

Each of the first to n^{th} average power regulators 135 to 137 is configured to regulate the average power of each piece of modulated additional data, respectively.

For example, the first average power regulator 135 is configured to regulate the average power of additional data modulated by the second modulator 131 and output the additional data, the average power of which has been regulated, to the coupler 115. Remaining average power regulators 137 are configured to perform similar operations as the first average power regulator 135. Each of the first to n^{th} average power regulators 135 to 137 may have the same average power regulation scheme, or a different one. Alternatively, only some of the average power regulators among the average power regulators 135, 137 may have the same average power regulation scheme.

The spreading unit 13 includes n channel encoders 123 to 125, n spreaders 127 to 129, n modulators 131 to 133, and n average power regulators 135 to 137. Therefore, each of the plural pieces of additional data distributed by the additional data distributor 121 has a different additional data transmission path.

A piece of additional data provided to the first channel encoder 123 is referred to as first additional data. The transmission path of the first additional data, for example, includes the first channel encoder 123, the first spreader 127, the second modulator 131, and the first average power regulator 135.

The coupler 115 is configured to couple the main service data, which has been modulated by the first modulator 113, and the plural pieces of additional data, the average power of which has been regulated by the first to n^{th} average power regulators 135 to 137, respectively, to generate a single piece of broadcasting data and output the single piece of generated broadcasting data to the transmitter 117.

The transmitter 117 is configured to convert the broadcasting data into a signal suitable for the wired/wireless transmission scheme and transmit the signal.

As such, the digital broadcast transmission apparatus 10 in accordance with the present invention uses a plurality of different spreading sequences for parallel processing of additional data, and simultaneously transmits the plural pieces of parallel-processed additional data together with main service data (i.e. plural pieces of additional data is transmitted simultaneously through broadcasting data), thereby improving data transmission performance.

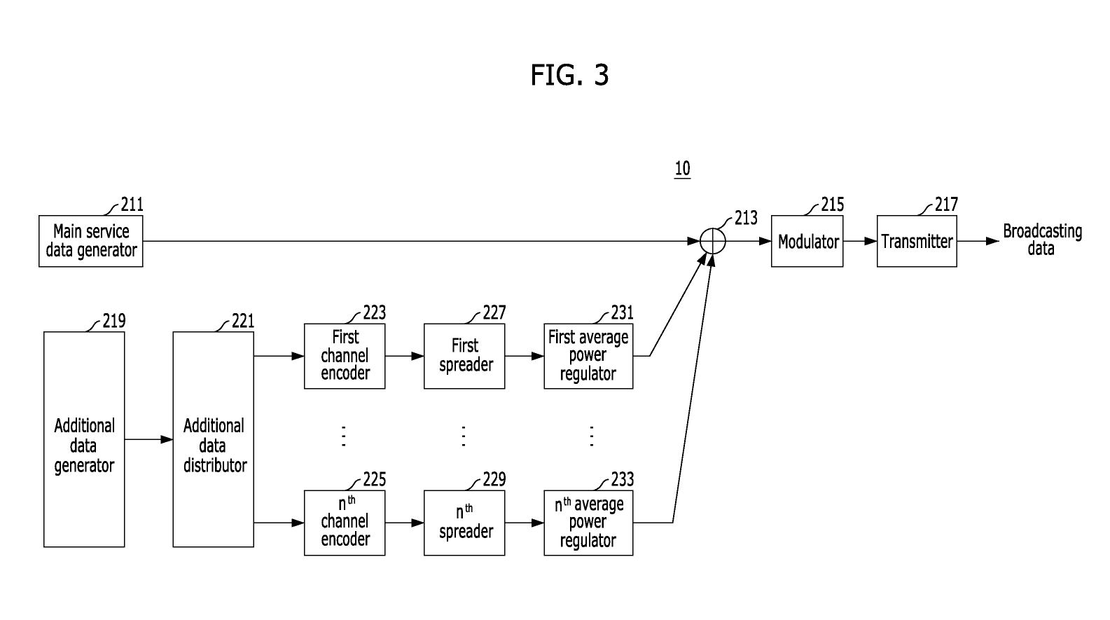

FIG. 3 illustrates the structure of a digital broadcast transmission apparatus in a digital broadcasting system in accordance with another embodiment of the present invention.

Referring to FIG. 3, the digital broadcast transmission apparatus 10 includes a main service data generation unit 11, an additional data generation unit 12, a spreading unit 13, and a transmission unit 14.

The main service data generation unit 11 includes a main service data generator 211. The additional data generation unit 12 includes an additional data generator 219 and an additional data distributor 221. The spreading unit 13 includes channel encoders 223 and 225, spreaders 227 and 229, and average power regulators 231 and 233. The transmission unit 14 includes a coupler 213, a modulator 215, and a transmitter 217.

The digital broadcast transmission apparatus 10 of FIG. 3 can be used when main service data and additional data are modulated by a single modulator 215.

The main service data generator 211 is configured to generate main service data and output the generated main service data to the first modulator 213.

The additional data generator 219 is configured to generate additional data and output the generated additional data to the additional data distributor 221.

The additional data distributor 221 is configured to distribute the additional data into plural pieces of additional data. The additional data distributor 221 may consider the kind, type, or size of additional data when distributing it. The additional data distributor 221 is configured to output the pieces of distributed additional data to the first to n^{th} channel encoders 223 to 225, respectively.

Each of the first to n^{th} channel encoders 223 to 225 is configured to perform channel encoding with regard to one of the plural pieces of additional data. As used herein, channel encoding refers to an encoding technique for reducing errors on the transmission path. For example, the first channel encoder 223 can insert redundancy for error detection and correction by the digital broadcast reception apparatus 20.

For example, the first channel encoder 223 can encode one of the plural pieces of additional data in the type of a channel encoding symbol. The first channel encoder 223 is configured to output the channel-encoded additional data to the first spreader 227. Remaining channel encoders 225 are configured to perform similar operations as the first channel encoder 223. Each of the first to n^{th} channel encoders 223 to 225 may have the same channel encoding scheme, or a different one. Alternatively, only some of the channel encoders among the channel encoders 23, 225 may have the same channel encoding scheme.

Each of the first to n^{th} channel spreaders 227 to 229 is configured to spread each piece of the channel-encoded additional data using a different spreading sequence. The spreading sequences may have orthogonality with regard to each other.

For example, the first spreader 227 is configured to spread additional data, which has been channel-encoded by the first channel encoder 223, using a first spreading sequence. The first spreader 227 is configured to output the spread additional data to first average power regulator 231. Remaining spreaders 229 are configured to perform similar operations as the first spreader 227. The n^{th} spreader 229 may use an n^{th} spreading sequence to spread additional data.

Therefore, the first and n^{th} spreading sequences are different ones.

Each of the first to n^{th} average power regulators 231 to 233 is configured to regulate the average power of each piece of modulated additional data, respectively.

For example, the first average power regulator 231 is configured to regulate the average power of additional data spread by the first spreader 227 and output the additional data, the average power of which has been regulated, to the coupler 213. Remaining average power regulators 233 are configured to perform similar operations as the first average power regulator 231. Each of the first to n^{th} average power regulators 231 to 233 may have the same average power regulation scheme, or a different one. Alternatively, only some of the average power regulators among the average power regulators 231,233 may have the same average power regulation scheme.

The spreading unit 13 includes n channel encoders 223 to 225, n spreaders 227 to 229, and n average power regulators 231 to 233. Therefore, each of the plural pieces of additional data distributed by the additional data distributor 221 has a different additional data transmission path.

A piece of additional data provided to the first channel encoder 223 is referred to as first additional data. The transmission path of the first additional data, for example, includes the first channel encoder 223, the first spreader 227, and the first average power regulator 231.

The coupler 213 is configured to couple the main service data, which has been generated by the first main service data generator 211, and the plural pieces of additional data, the average power of which has been regulated by the first to n^{th} average power regulators 231 to 233, respectively, to generate a single piece of broadcasting data and output the single piece of generated broadcasting data to the modulator 215.

The modulator 215 is configured to modulate the single piece of broadcasting data according to a predetermined modulation scheme and output the single piece of modulated broadcasting data to the transmitter 217.

The transmitter 217 is configured to convert the broadcasting data into a signal suitable for the wired/wireless transmission scheme and transmit the signal.

As such, the digital broadcast transmission apparatus 10 can improve data transmission efficiency through parallel processing of additional data using spreading sequences, as in the case of FIG. 2. That is, plural pieces of additional data are transmitted simultaneously through broadcasting data, thereby improving data transmission performance.

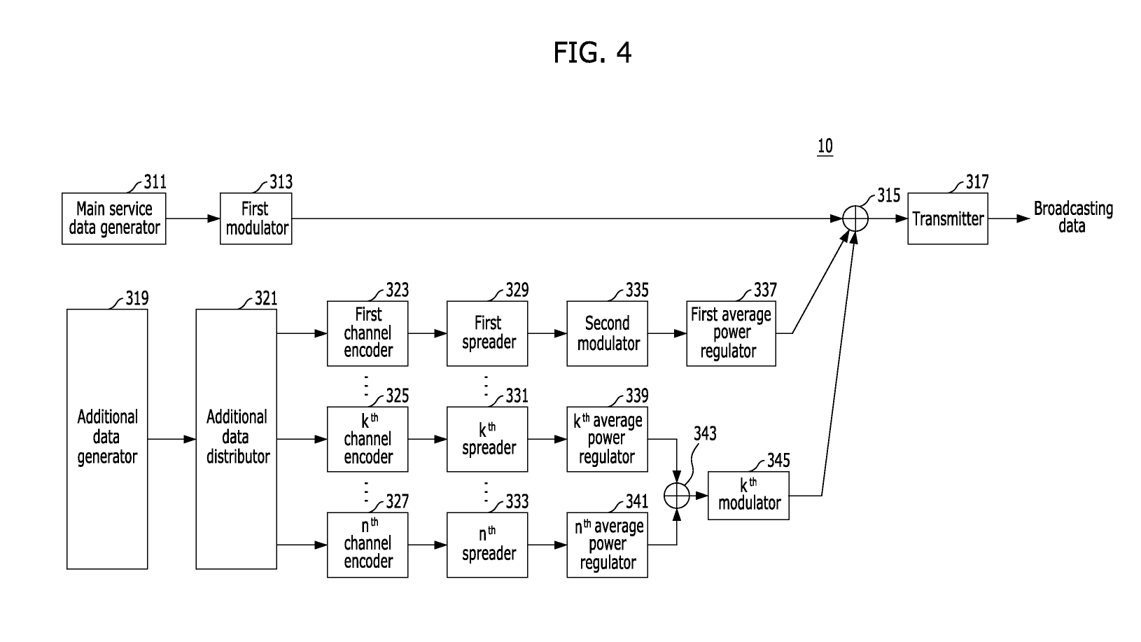

FIG. 4 illustrates the structure of a digital broadcast transmission apparatus in a digital broadcasting system in accordance with still another embodiment of the present invention.

Referring to FIG. 4, the digital broadcast transmission apparatus 10 includes a main service data generation unit 11, an additional data generation unit 12, a spreading unit 13, and a transmission unit 14.

The main service data generation unit 11 includes a main service data generator 311 and a first modulator 313. The additional data generation unit 12 includes an additional data generator 319 and an additional data distributor 321. The spreading unit 13 includes channel encoders 323, 325, and 327, spreaders 329, 331, and 333, modulators 335 and 345, average power regulators 337, 339, and 341, and a first coupler 343. The transmission unit 14 includes a second coupler 315 and a transmitter 317.

The digital broadcast transmission apparatus 10 of FIG. 4 can be used when a part of the additional data is modulated by a modulator 345. In this case, the digital broadcast transmission apparatus 10 modulates the main service data and the remaining additional data using different modulators 313 and 335, respectively.

The main service data generator 311 is configured to generate main service data and output the generated main service data to the first modulator 313.

The first modulator 313 is configured to modulate the main service data according to a predetermined first modulation scheme and output the modulated main service data to the coupler 315.

The additional data generator 319 is configured to generate additional data and output the generated additional data to the additional data distributor 321.

The additional data distributor 321 is configured to distribute the additional data into plural pieces of additional data. The additional data distributor 321 may consider the kind, type, or size of additional data when distributing it. The additional data distributor 321 is configured to output the pieces of distributed additional data to the first to n^{th} channel encoders 323 to 327, respectively.

Each of the first to n^{th} channel encoders 323 to 327 is configured to perform channel encoding with regard to one of the plural pieces of additional data. As used herein, channel encoding refers to an encoding technique for reducing errors on the transmission path. For example, the first channel encoder 323 can insert redundancy for error detection and correction by the digital broadcast reception apparatus 20.

For example, the first channel encoder 323 can encode one of the plural pieces of additional data in the type of a channel encoding symbol. The first channel encoder 323 is configured to output the channel-encoded additional data to the first spreader 329. Remaining channel encoders 325 and 327 are configured to perform similar operations as the first channel encoder 323. Each of the first to n^{th} channel encoders 323 to 327 may have the same channel encoding scheme, or a different one. Alternatively, only some of the channel encoders among the channel encoders 323, 325, 327 may have the same channel encoding scheme.

Each of the first to n^{th} channel spreaders 329 to 333 is configured to spread each piece of the channel-encoded additional data using a different spreading sequence. The spreading sequences may have orthogonality with regard to each other.

For example, the first spreader 329 is configured to spread additional data, which has been channel-encoded by the first channel encoder 323, using a first spreading sequence. The first spreader 329 is configured to output the spread additional data to the second modulator 335.

And, the k^{th} spreader 331 is configured to spread additional data, which has been channel-encoded by the k^{th} channel encoder 325, using a k^{th} spreading sequence. The k^{th} spreader 331 is configured to output the spread additional data to the k^{th} average power regulator 339. The n^{th} spreader 333 is configured to spread additional data, which has been channel-encoded by the n^{th} channel encoder 327, using a n^{th} spreading sequence. The n^{th} spreader 333 is configured to output the spread additional data to the n^{th} average power regulator 341. The pieces of additional data spread by the k^{th} to n^{th} spreaders 331 to 333 are modulated by a single modulator, i.e. the k^{th} modulator 345.

The first spreading sequence, the k^{th} spreading sequence, and the n^{th} spreading sequence are different from one another.

The second modulator 335 is configured to modulate additional data, which has been spread by the first spreader 329, according to a predetermined second modulation scheme and output the modulated additional data to the first average power regulator 337.

Each of the first to n^{th} average power regulators 337 to 341 is configured to regulate the average power of each piece of modulated additional data, respectively.

For example, the first average power regulator 337 is configured to regulate the average power of additional data modulated by the second modulator 335 and output the additional data, the average power of which has been regulated, to the coupler 315.

And, the k^{th} average power regulator 339 is configured to regulate the average power of additional data spread by the k^{th} spreader 331. The n^{th} average power regulator 341 is configured to regulate the average power of additional data spread by the n^{th} spreader 333. Each of the k^{th} average power regulator 339 and the n^{th} average power regulator 341 is configured to output each piece of additional data, respectively, the average power of which has been regulated, to the first coupler 343.

Each of the first to n^{th} average power regulators 337 to 341 may have the same average power regulation scheme, or a different one. Alternatively, only some of the average power regulators among the average power regulators 337, 339, 341 may have the same average power regulation scheme.

The first coupler 343 is configured to couple pieces of additional data, the average power of which have been regulated by the k^{th} to n^{th} average power regulators 339 to 341, respectively, and output the coupled pieces of additional data to the k^{th} modulator 345.

The k^{th} modulator 345 is configured to modulate additional data, which has been coupled by the first coupler 343, using to a predetermined k^{th} modulation scheme and output the modulated additional data to the second coupler 315.

The first modulation scheme of the first modulator 313, the second modulation scheme of the second modulator 335, and the k^{th} modulation scheme of the k^{th} modulator 345 may all be the same, or different from one another. Alternatively, only some of the modulators among the modulators 313, 335, 345 have the same modulation scheme.

The spreading unit 13 includes n channel encoders 323, 325, and 327, n spreaders 329, 331, and 333, k modulators 335 and 345, and n average power regulators 337, 339, and 341. Therefore, each of the plural pieces of additional data distributed by the additional data distributor 321 has a different additional data transmission path.

A piece of additional data provided to the first channel encoder 323 is referred to as first additional data. The transmission path of the first additional data, for example, includes the first channel encoder 323, the first spreader 329, the second modulator 335, and the first average power regulator 337. A piece of additional data provided to the k^{th} channel encoder is referred to as k^{th} additional data. The transmission path of the k^{th} additional data includes the k^{th} channel encoder 325, the k^{th} spreader 331, the k^{th} average power regulator 339, the first coupler 343, and the k^{th} modulator 345.

The second coupler 315 is configured to couple the main service data, which has been modulated by the first modulator 313, the additional data, the average power of which has been regulated by the first average power regulator 337, and the additional data modulated by the k^{th} modulator 345 to generate a single piece of broadcasting data and output the single piece of generated broadcasting data to the transmitter 317.

The transmitter 317 is configured to convert the broadcasting data into a signal suitable for the wired/wireless transmission scheme and transmit the signal.

As such, the digital broadcast transmission apparatus 10 can improve data transmission efficiency through parallel processing of additional data using spreading sequences, as in the case of FIG. 2. That is, plural pieces of additional data are transmitted simultaneously through broadcasting data, thereby improving data transmission performance.

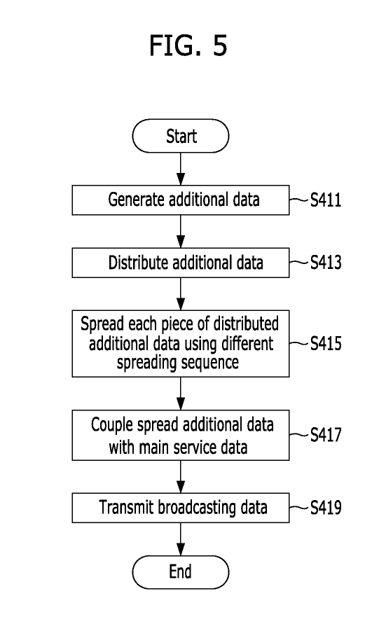

FIG. 5 illustrates exemplary operation of the digital broadcast transmission apparatus in a digital broadcasting system in accordance with an embodiment of the present invention.

Referring to FIG. 5, the digital broadcast transmission apparatus 10 generates main service data and additional data at step S411.

The digital broadcast transmission apparatus 10 distributes the additional data in order to spread it using different plural pieces of spreading sequences at step S413.

The digital broadcast transmission apparatus 10 spreads each of the plural pieces of distributed additional data using a different spreading sequence at step S415. The digital broadcast transmission apparatus 10 can parallel-process the plural pieces of distributed additional data and transmit them simultaneously. The digital broadcast transmission apparatus 10 can perform channel encoding, modulation, or average power regulation with regard to each of the plural pieces of distributed additional data.

The digital broadcast transmission apparatus 10 couples the distributed additional data with the main service data at step S417. The digital broadcast transmission apparatus 10 can simultaneously transmit plural pieces of additional data through broadcasting data by using different plural pieces of spreading sequences.

The digital broadcast transmission apparatus 10 transmits broadcasting data at step S419. The digital broadcast transmission apparatus 10 ends operation after transmission of the broadcasting data is completed.

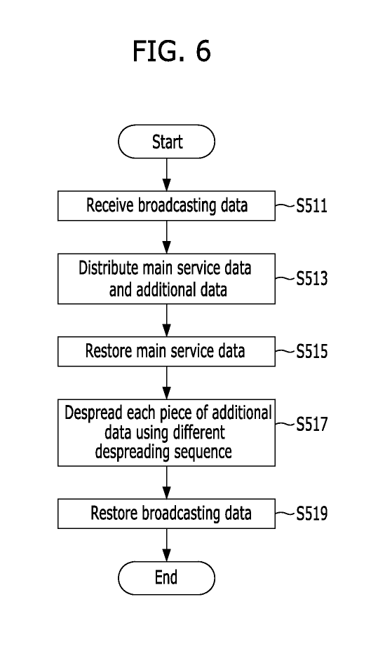

FIG. 6 illustrates exemplary operation of the digital broadcast reception apparatus in a digital broadcasting system in accordance with an embodiment of the present invention.

Referring to FIG. 6, the digital broadcast reception apparatus 20 receives broadcasting data at step S511.

The digital broadcast reception apparatus 20 distributes each of main service data and additional data from the broadcasting data at step S513.

The digital broadcast reception apparatus 20 processes the main service data at step S515.

The digital broadcast reception apparatus 20 despreads each piece of additional data using a different despreading sequence at step S517. The digital broadcast reception apparatus 20 can use despreading sequences corresponding to spreading sequences of the digital broadcast transmission apparatus 10 in order to despread the additional data.

The digital broadcast reception apparatus 20 processes the additional data at step S519. The digital broadcast reception apparatus 20 ends operation when processing of the additional data is completed.

It is to be noted that the steps S515 and S519 have been described as examples, i.e. the digital broadcast reception apparatus 20 can process main service data and additional data simultaneously, or process one of the main service data and additional data first.

The present invention will now be described in connection with the structure of the digital broadcast transmission apparatus 10. It is to be noted that the digital broadcast reception apparatus 20 in accordance with the present invention can process broadcasting data based on a structure corresponding to that of the digital broadcast transmission apparatus 10.

In a digital broadcasting system in accordance with the present invention, the digital broadcast transmission apparatus 10 and the digital broadcast reception apparatus 20 can simultaneously transmit plural pieces of additional data through spreading and despreading, respectively.

That is, the digital broadcast transmission apparatus 10 distributes additional data into plural pieces of additional data and spreads each piece of distributed additional data using different plural pieces of spreading sequences. Through this process, the digital broadcast transmission apparatus 10 simultaneously transmits plural pieces of additional data, which have been spread using different spreading sequences, through broadcasting data. As a result, the digital broadcast transmission apparatus 10 improves performance of transmitting broadcasting data for unit time. The improved data transmission performance increases the amount of data provided to the user by the digital broadcast reception apparatus 20.

In accordance with the exemplary embodiments of the present invention, additional data is spread using a plurality of spreading sequences, and the resulting plural pieces of additional data are coupled with main service data and then transmitted. This improves data transmission performance of the digital broadcast transmission apparatus.

While the present invention has been described with respect to the specific embodiments, it will be apparent to those skilled in the art that various changes and modifications may be made without departing from the spirit and scope of the invention as defined in the following claims.

What is claimed is:

1. An apparatus for transmitting digital broadcasts in a digital broadcasting system, comprising:
a main service data generation unit configured to generate main service data;
an additional data generation unit configured to generate plural pieces of additional data;
a spreading unit configured to spread the plural pieces of additional data using different plural pieces of spreading sequences, respectively; and
a transmission unit configured to couple each of the plural pieces of spread additional data with the main service data and transmit the coupled data into a single piece of broadcasting data.

2. The apparatus of claim 1, wherein the main service data generation unit comprises a main service data generator configured to generate the main service data.

3. The apparatus of claim 1, wherein the additional data generation unit comprises:
an additional data generator configured to generate the plural pieces of additional data; and
an additional data distribution unit configured to distribute the plural pieces of additional data, respectively.

4. The apparatus of claim 1, wherein the spreading unit comprises:
channel encoders configured to channel-encode the plural pieces of additional data, respectively; and
spreaders configured to spread the plural pieces of channel-encoded additional data using the different plural pieces of spreading sequences, respectively.

5. The apparatus of claim 4, wherein the spreading unit further comprises average power regulators configured to regulate average power of the plural pieces of additional data spread by the spreaders, respectively.

6. The apparatus of claim 5, wherein the transmission unit comprises:
a coupler configured to couple the main service data and the plural pieces of average power-regulated additional data and generate the single piece of broadcasting data;
a modulator configured to modulate the single piece of generated broadcasting data according to a predetermined modulation scheme; and
a transmitter configured to transmit the single piece of modulated broadcasting data.

7. The apparatus of claim 2, wherein the main service data generator further comprises a first modulator configured to modulate the main service data.

8. The apparatus of claim 7, wherein the spreading unit further comprises:
second modulators configured to modulate the plural pieces of spread additional data, respectively; and
first average power regulators configured to regulate average power of the plural pieces of modulated additional data, respectively.

9. The apparatus of claim 8, wherein the transmission unit comprises:
a coupler configured to couple the modulated main service data and the plural pieces of average power-regulated additional data and generate the single piece of broadcasting data; and
a transmitter configured to transmit the single piece of broadcasting data.

10. The apparatus of claim 8, wherein the spreading unit further comprises:
second average power regulators configured to regulate average power of part of the plural pieces of spread additional data, respectively;
a first coupler configured to couple the plural pieces of average power-regulated additional data by the second average power regulators; and
a third modulator configured to modulate the plural pieces of coupled additional data by the first coupler.

11. The apparatus of claim 10, wherein the transmission unit comprises:
a coupler configured to couple the modulated main service data, the plural pieces of average power-regulated additional data by the first average power regulators, and the plural pieces of modulated additional data by the third modulator and generate the single piece of broadcasting data; and
a transmitter configured to transmit the single piece of broadcasting data.

12. An apparatus for transmitting digital broadcasts in a digital broadcasting system, comprising:
a main service data generator configured to generate main service data;
a first modulator configured to modulate the main service data according to a predetermined first modulation scheme;
an additional data generator configured to generate additional data;
an additional data distributor configured to distribute the additional data into plural pieces of additional data;
spreaders configured to spread the plural pieces of distributed additional data using different plural pieces of predetermined spreading sequences, respectively;
second modulators configured to modulate the plural pieces of spread additional data according to a predetermined second modulation scheme, respectively;
a first coupler configured to couple the modulated main service data and each of the plural pieces of modulated additional data and generate a single piece of broadcasting data; and
a transmitter configured to signal-process the single piece of broadcasting data and transmit the single piece of signal-processed broadcasting data.

13. The apparatus of claim 12, further comprising channel encoders configured to channel-encode the plural pieces of distributed additional data and output the spreaders with the plural pieces of channel-encoded additional data, respectively.

14. The apparatus of claim 12, further comprising average power regulators configured to regulate average power of the plural pieces of modulated additional data and output the plural pieces of average power-regulated additional data to the first coupler, respectively.

15. The apparatus of claim 12, further comprising:
a second coupler configured to couple part of the plural pieces of spread additional data; and
a third modulator configured to modulate the additional data coupled by the second coupler according to a predetermined third modulation scheme and output the modulated additional data to the first coupler.

16. An apparatus for transmitting digital broadcasts in a digital broadcasting system, comprising:
a main service data generator configured to generate main service data;
an additional data generator configured to generate additional data;
an additional data distributor configured to distribute the additional data into plural pieces of additional data;
spreaders configured to spread the plural pieces of distributed additional data using different plural pieces of predetermined spreading sequences, respectively;
a coupler configured to couple the main service data and each of the plural pieces of spread additional data and generate a single piece of broadcasting data;
a modulator configured to modulate the single piece of broadcasting data according to a predetermined modulation scheme; and
a transmitter configured to signal-process the single piece of modulated broadcasting data and transmit the single piece of signal-processed broadcasting data.

17. The apparatus of claim 16, further comprising channel encoders configured to channel-encode the plural pieces of distributed additional data and output the plural pieces of channel-encoded additional data to the spreaders, respectively.

18. The apparatus of claim 16, further comprising average power regulators configured to regulate average power of each of the plural pieces of spread additional data and output the average power-regulated additional data to the coupler.

19. A method for transmitting data by a digital broadcast transmission apparatus in a digital broadcasting system, comprising:
generating main service data and additional data;
distributing the additional data into plural pieces of additional data;
spreading the plural pieces of distributed additional data using different plural pieces of spreading sequences, respectively; and
coupling the main service data and the plural pieces of spread additional data and transmitting the single piece of coupled broadcasting data.

20. The method of claim 19, wherein in the plural pieces of spread sequences have orthogonality with regard to one another, respectively.
